(19) United States
(12) Patent Application Publication
(10) Pub. No.: US 2004/0035302 A1
(43) Pub. Date: Feb. 26, 2004

(54) Belt calender

(76) Inventors: Markus Laitila, Jarvenpaa (FI); Mika Viljanmaa, Helsinki (FI)

Correspondence Address: STEINBERG & RASKIN, P.C., 1140 AVENUE OF THE AMERICAS, 15th FLOOR, NEW YORK, NY, 10036-5803, US

(21) Appl. No.: 10/257,688

(22) PCT Filed: May 3, 2001
(86) PCT No.: PCT/FI01/00419

(30) Foreign Application Priority Data
May 3, 2000 (FI) 20001025

(51) Int. Cl. B30B 3/00

(52) U.S. Cl. 100/153

(57) ABSTRACT

The invention relates to a belt calender, comprising a first roll (11), a second roll (13; 15), and a belt loop therebetween, comprising an incompressible metal belt (12) pressed by the second roll (13; 15) against the first roll (11) to establish a calendering zone between the first roll (11) and said belt (12). The second roll (13; 15) is provided with a compressible belt section (14; 18) to be pressed against the metal belt (12).

The invention relates to a belt calender, comprising a first roll, a second roll, and a belt loop therebetween, comprising an incompressible metal belt pressed by the second roll against the first roll to establish a calendering zone between the first roll and said belt.

The invention relates further to a method for calendering a web of material in a belt calender, comprising a first belt, a second belt, and a belt loop therebetween, comprising an incompressible metal belt pressed by the second roll against the first roll to establish a calendering zone between the first roll and said belt.

In an effort to raise the level of calendering, the only practical possibility has been to increase the number of calendering nips. This has led to a more complicated calender construction and more difficult control and threading of the paper web. Particularly, in reference to on-line machines, a solution must be found to contradictions arising from high running speed and full-speed web threading. Attempts have been made to solve these problems with various belt and shoe calenders for extending a calendering nip to enhance thereby the nip operation. For example, paper to be calendered with belt calenders is carried by means of an endless belt to a preliminary contact with a hot calender roll, thus enabling the creating of a steep temperature gradient favourable from the viewpoint of calendering. By means of the belt, the effective length of a nip is extended by virtue of the preliminary contact as well as for the reason that the belt material enables the use of polymers which are considerably softer than those used in roll coatings, without problems resulting from deformations related to heat. With a nip more extended than in a supercalender or soft calender, the press impulse applied to the paper can be increased without the pressure peak becoming excessively high and without reducing the bulk.

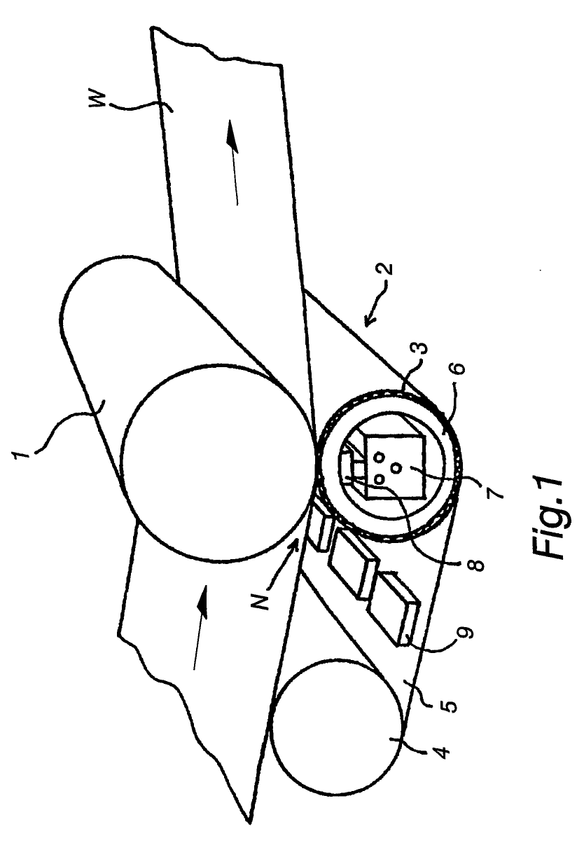

One solution for a belt calender has been disclosed earlier e.g. in Finnish patent publication No. 95061. A calender embodiment according to this cited publication is shown schematically in FIG. 1 of the drawings, depicting the prior art.

In the prior art calender shown in FIG. 1, a calendering nip N is formed between a heatable hard roll 1 and a calendering belt, preferably a metal belt 5, supported by an elastic surface roll 2. The metal belt 5 is an endless belt and could be e.g. steel in its material. The belt has been extended over the nip roll 2 and a reversing roll 4, the former being lined with an elastic coating 3. In this prior art calender, the calendering nip N is formed between the heatable hard roll 1 and said metal belt 5 supported by the calender roll 2 lined with an elastic coating. Such a solution is largely consistent with the nip of a soft calender, wherein, however, the metal belt 5 enables both sides of a paper W to be subjected to a substantially identical treatment and, thus, the glazing to occur simultaneously on either side of the paper W.

It is an object of the present invention to provide an improved belt calender solution, capable of providing a long-nip calender, which further enables the application of a relatively high pressure. In order to accomplish this object, a belt calender of the invention, comprising a first roll, a second roll, and a belt loop therebetween, comprising an incompressible metal belt pressed by the second roll against the first roll to establish a calendering zone between the first roll and said belt, is characterized in that the second roll is provided with a compressible belt section to be pressed against the metal belt.

On the other hand, a method of the invention is characterized in that the first roll is constituted by a polymer-coated roll, the second roll is constituted by a roll which is provided with a compressible belt section to be pressed against a metal belt, the web of material to be calendered in said method being passed through a nip between the polymer-coated roll and the metal belt.

The invention provides a solution which enables a wide range of pressure control accompanied by a concurrent wide range of operating speeds. In addition, the use of an incompressible metal belt and a roll supporting the same at the nip and provided with a compressible belt enables the creation of a finishing zone, which has an extremely high-quality surface, is resilient and highly compliant with a web surface in accordance with loading. Other benefits and characterizing features of the invention shall be described in a more detailed specification hereinafter.

FIG. 1 shows a calender of the prior art, wherein a calendering nip is established by means of a heatable hard roll and an endless metal belt supported by a roll provided with an elastic coating.

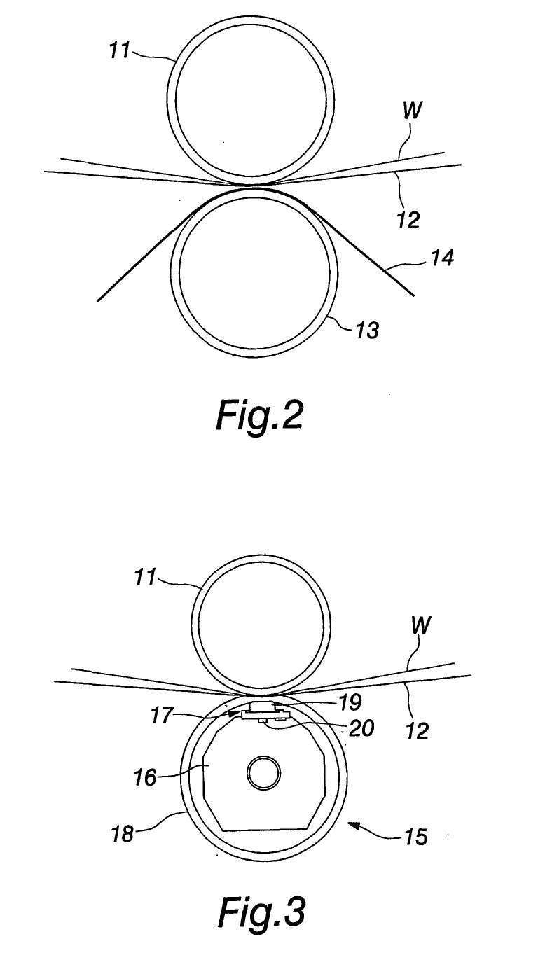

FIG. 2 shows in a schematic side view a calendering nip arrangement according to one embodiment of the invention, and

FIG. 3 shows a second calendering nip arrangement of the invention in a view similar to FIG. 1.

The prior art belt calender arrangement of FIG. 1 comprises a roll 1 which is a heatable hard-surface roll, and a roll 2 which is a deflection-compensated roll provided with an elastic coating 3, wherein a roll shell 6 is adapted to rotate around a stationary roll shaft 7. The roll shell 6 is loaded towards a nip N with loading elements 8. Such a zone-controlled roll can be used for equalizing a loading on the nip N laterally of the web and the loading can be adjusted whenever necessary or desirable. Reference numeral 9 designates heating elements, e.g. induction heaters in the case of a metal belt 5. Reference numeral 4 indicates a guide roll, over which the metal belt 5 extends.

FIG. 2 depicts one embodiment of the invention, wherein reference numeral 11 indicates a first roll, comprising e.g. a thermal roll or a polymer-coated roll. Reference numeral 13 refers to a second roll, comprising in the present embodiment a hard-surface roll, around which is adapted to run a compressible belt 14 which additionally extends over guide rolls, not shown. Between the rolls 11 and 13 extends an incompressible metal belt 12, which is adapted to be heatable, if necessary. A calendering nip N is formed between the first roll 11 and the metal belt 12. Reference character W refers to a web of material, which passes through the nip N.

In FIG. 3, a first roll is likewise designated with reference numeral 11 and it may comprise either a polymer-coated roll or a thermo roll. On the other hand, reference numeral 15 is used for a shoe roll, wherein a stationary shaft 16 is provided with a loading element 17 in line with a nip N, comprising a shoe member 19 extending across the width of the nip, and pistons 20 applying a load thereto. A compressible belt shell 18 is adapted to extend around the shoe 19. As in the case of FIG. 2, an incompressible metal belt 12 is adapted to extend through between the roll 11 and the second roll 15 to establish the nip N between the metal belt 12 and the first roll 11, a web of material W passing through said nip N.

When the first roll in a belt calender of the invention comprises a polymer-coated roll, the metal belt is adapted to be heatable. Respectively, when the first roll 11 comprises a heatable chilled roll, a so-called thermo roll, the metal belt 12 is preferably adapted to be cooled with known techniques.

One benefit gained by a solution of the invention is that a resilient or elastic belt can be provided with substantially softer polymers than in a polymer-coated roll, whereby the nip can be extended. In addition, the belt calender of the invention enables the establishment of a nip between a polymer-coated roll and a metal belt.

1. A belt calender, comprising a first roll (11), a second roll (13; 15), and a belt loop therebetween, comprising an incompressible metal belt (12) pressed by the second roll (13; 15) against the first roll (11) to establish a calendering zone between the first roll (11) and said belt (12), characterized in that the second roll (13; 15) is provided with a compressible belt section (14; 18) to be pressed against the metal belt (12).

2. A belt calender as set forth in claim 1, characterized in that the second roll comprises a hard-surface roll (13), which is provided with a compressible belt (14) extending through between the metal belt (12) and the hard-surface roll (13) and around the hard-surface roll (13).

3. A belt calender as set forth in claim 1, characterized in that the second roll comprises a shoe roll (15), which is provided with a compressible belt shell (18).

4. A belt calender as set forth in any of claims 1-3, characterized in that the first roll (11) comprises a polymer-coated roll, and that the metal belt (12) is adapted to be heatable and/oir coolable.

5. A belt calender as set forth in any of claims 1-3, characterized in that the first roll (11) comprises a heatable hard-surface roll.

6. A method for calendering a web of material in a belt calender, comprising a first belt (11), a second belt (13; 15), and a belt loop therebetween, comprising an incompressible metal belt (12) pressed by the second roll (13; 15) against the first roll (11) to establish a calendering zone between the first roll (11) and said belt (12), characterized in that the first roll (11) is constituted by a polymer-coated roll, the second roll (13; 15) is constituted by a roll which is provided with a compressible belt section (14; 18) to be pressed against the metal belt (12), the web of material to be calendered in said method being passed through a nip between the polymer-coated roll (11) and the metal belt (12).

7. A method as set forth in claim 6, characterized in that the metal belt (12) is heatable and/or coolable in said method.
